(19) United States
(12) Patent Application Publication
(10) Pub. No.: US 2015/0328658 A1
(43) Pub. Date: Nov. 19, 2015

(54) METHOD FOR TRANSFERRING A TRANSFER FLUID FROM A SUPPLY SURFACE INTO A PLURALITY OF DISCRETE COMPARTMENTS ON A TARGET SURFACE AND TRANSFER SURFACE FOR CARRYING OUT THE METHOD

(71) Applicant: KARLSRUHER INSTITUT FÜR TECHNOLOGIE, Karlsruhe (DE)

(72) Inventor: Bastian RAPP, Karlsruhe (DE)

(21) Appl. No.: 14/652,793

(22) PCT Filed: Dec. 7, 2013
(86) PCT No.: PCT/EP2013/003695

§ 371 Date: Jun. 17, 2015

(30) Foreign Application Priority Data
Dec. 18, 2012 (DE) 10 2012 112 494.9

(51) Int. Cl. B05D 1/28; B05C 1/00

(52) U.S. Cl. CPC B05D 1/28; B05C 1/00

(57) ABSTRACT

A method for transferring a first transfer fluid from a supply surface into a plurality of discrete supply compartments on a target surface which is configured such that the first transfer fluid has a tendency to adhere more easily to the supply compartments than to the substrate between the supply compartments includes providing a transfer surface which has a plurality of discrete transfer compartments, wherein each transfer compartment can be, independently of all the other transfer compartments, switched between a first wetting behavior with respect to the first transfer fluid and a second wetting behavior having a degree of wetting which is different from that of the first wetting behavior and setting all of the transfer compartments to the first wetting behavior. The method further includes configuring selected transfer compartments to the second wetting behavior by means of a first high-energy action.

### CROSS REFERENCE TO RELATED APPLICATIONS

This application is a U.S. National Phase application under 35 U.S.C. §371 of International Application No. PCT/EP2013/003695 (WO 2014/094992 A1), filed on Dec. 7, 2013, and claims benefit to German Patent Application No. DE 10 2012 112 494.9, filed Dec. 18, 2012. The International Application was published in German on Jun. 26, 2014 as WO 2014/094992 under PCT Article 21(2).

### FIELD

The invention relates to methods and devices for fluid transfer, and in particular to methods and devices for fluid transfer from a supply surface into a plurality of spatially separated compartments on a target surface.

### BACKGROUND

In many fields of technology it is necessary to apply a plurality of substances which are in a liquid phase in each case to the surface of a substrate. An illustrative example of this is a sheet of paper printed with an image, on the surface of which different fluids are deposited beforehand in such a manner that the image is thereby produced. The fluids used for this are provided with coloured pigments, with as a rule three or four different fluids being used for colour printing. Another example relates to a plurality of chemical solutions with which one or more chemical reactions are carried out on a substrate.

A method for transferring fluids by means of a mechanically structured surface by micro-contact printing is known from DE 199 499 93 C1 or EP 2 150 854 A1. Static elastomeric stamps are used for this, these being chemically modified at least in part in such a way as to change the wetting suitability of the surfaces permanently.

A further method for transferring fluids by controlling wetting properties, in particular by electrowetting, is known from US 2007/243110 A1. What is disadvantageous about this is that large electric fields are necessary for this and the electrodes used require relatively large volumes of fluid. A device which is embodied as a free surface is known from DE 10 2006 004 887 B4. What is disadvantageous about this is that no discrete fluid compartments can be produced therewith.

It is known from H. S. Lim, J. T. Han, D. Kwak, M. Jin and Kilwon Cho, Photoreversibly Switchable Superhydrophobic Surface with Erasable and Rewritable Pattern, J. Am. Chem. Soc. 2006, 128, 14458-14459 to change wetting properties by means of light: this is referred to as opto-wetting. Therein, it is described how a change in the wetting behaviour against water from superhydrophilic, i.e. a contact angle of <10°, to superhydrophobic, i.e. a contact angle of >170°, is achieved on pre-treated surfaces. For this, azo compounds which have a thermodynamically stable trans-conformation (molecule is extended) and a thermodynamically unstable cis-conformation (molecule is folded inwards) are applied to the surface, it being possible to isomerise them by means of irradiation.

Such effects are also known from the use of ceramic substrates or semiconductors, where transformations from crystalline to amorphous states are effected by exposure to light. The structured regions have different physical properties, in particular different surface conductances, tensions or roughnesses, which change the wetting behaviour of the structured regions compared with the non-structured regions.

DE 2 111 561 C2 discloses such a method for semiconductor layers which contain tellurium. Zirconia ceramics are also suitable for such a method. These materials are hydrophilic in the untreated state, and become more hydrophobic after exposure to light, the changes in the contact angle being slight. For example, EP 0 769 372 A1 describes an increase in the contact angle against water of the order of approx. 20°. Zinc oxide and titanium oxide ceramics are also suitable for such applications, as is known from EP 0 911 155 A1. EP 0 903 223 A1 in such case discloses changes in contact angle of up to 70°. What is disadvantageous about this is that the substrates used require high radiant intensities, although only slight contrasts in wetting behaviour can be achieved therewith.

Structured substrates are frequently used in the printing industry, with a distinction being made between ink-repelling and ink-attracting regions. Methods in which a repelling (or attracting) first layer is applied which is then covered with an attracting (or repelling, respectively) second layer serve to produce these substrates, as is disclosed in WO 03/070461 A1. The second layer is then eroded locally again by means of an energy input, in particular in the form of heat or radiation, to produce an image, as a result of which a pattern which accepts a liquid solution, in particular an ink, forms on the surface, corresponding to the pattern applied.

Alternatively, as described in EP 0 522 804 A1, an ink-attracting (or ink-repelling, respectively) second layer is applied only to desired partial regions of the first layer. What is disadvantageous in this case is that the substrate has to be coated anew every time after it has been used, since the configuring is a physical coating or erosion process.

A method for selective structuring of a surface by means of a heat or radiation source is described in DE 196 12 927 A1. Here, a polymer coating applied to a substrate is structured by means of radiation, as a result of which its surface property changes from hydrophilic to hydrophobic, as a result of which a structured surface which is suitable for selective fluid transfer is produced. In this case, the effect as a rule is incapable of being reversed, since the radiation introduced results in an irreversible change in the material properties. This disadvantage is countered by a device which is capable of removing a layer once structured from the substrate again in order to re-coat it for a renewed transfer operation.

US 2005/028698 A1 describes a substrate which is coated with a material which is either hydrophilic or hydrophobic, depending on temperature. In this case, first of all the entire surface is converted into one of the two states, preferably that state which exists at the lower temperature being selected. Then the substrate is locally structured with a pattern by means of radiation such that regions with a different wetting behaviour are produced. The pattern is fleeting, since the thermal conductivity of the surface causes temperature gradients to disappear over time. Therefore this arrangement is very sensitive to environmental effects, but above all to thermal loads, in particular to the precipitation of moisture on the surface or due to the application of the fluid to be transferred.

WO 97/36746 A1 discloses the use of films of water which are first of all applied homogeneously to a substrate, and which are selectively evaporated by means of a radiation or heat source. In the exposed regions, the substrate surface has a different wetting tendency from that in the non-exposed regions, as a result of which an adjustable surface pattern forms. Furthermore, DE 101 32 204 A1 describes the use of films of water in the frozen state. What is disadvantageous about this is that an additional layer has to be physically applied. Likewise, it is necessary to preserve the integrity of the layer in the method; the layer has to be removed and re-applied after the transfer. Since in many applications aqueous solutions are used for transfer, such an arrangement is unsuitable owing to contamination and cross-mixing effects.

U.S. Pat. No. 4,718,340 A discloses a method in which a monomolecular coating is used to produce surfaces with different wetting tendencies. In this case too, a hydrophilic (or hydrophobic) substrate is coated with a substance which in an ideal case forms a monomolecular hydrophobic (or hydrophilic, respectively) layer. The layer is then physically removed, preferably mechanically or by energy input, in particular by means of heat or radiation. With this method too, the layer always has to be renewed after it has been used.

EP 0 963 839 A1 discloses the transfer of ink onto a target surface via an inking roller. Variable transfer is made possible by the surface of the inking roller consisting of a material, the wetting properties of which are reversibly changeable between a state with a small contact angle and a state with a large contact angle, the state with a very small contact angle being achieved by the action of light, the wavelength of which is shorter than a material-specific wavelength.

Methods known from the printing industry provide for a closed surface to appear as a closed surface in the finished print image as well. In order to avoid a pixellated image, to have fluids which are arranged adjacent flow into one another is an eminently desirable effect. Furthermore, the contrasts in wetting behaviour should not be too great, in order to avoid complete transfer of the transfer fluid onto the target surface, since a configured print roller which is wetted with ink should produce as large as possible a number of replicas.

### SUMMARY OF THE INVENTION

A method is provided for transferring a first transfer fluid from a supply surface into a plurality of discrete supply compartments on a target surface which is configured such that the first transfer fluid has a tendency to adhere more easily to the supply compartments than to the substrate between the supply compartments. The method includes providing a transfer surface which has a plurality of discrete transfer compartments, wherein each transfer compartment can be, independently of all the other transfer compartments, switched between a first wetting behavior with respect to the first transfer fluid and a second wetting behavior having a degree of wetting which is different from that of the first wetting behavior and setting all of the transfer compartments to the first wetting behavior. The method further includes configuring selected transfer compartments to the second wetting behavior by means of a first high-energy action, so that the selected transfer compartments bear a first configuration and bringing the transfer surface into contact with the supply surface, as a result of which the selected transfer compartments receive first transfer fluid applied to the supply surface. The method additionally includes removing the transfer surface from the supply surface, after which second selected transfer compartments contain the first transfer fluid, positioning the transfer surface above the target surface such that the second selected transfer compartments are disposed above the supply compartments of the target surface, clearing the configuration of at least a portion of the second selected transfer compartments due to passage of time or by applying a second high-energy action on the transfer surface, as a result of which the first transfer fluid leaves from the second selected transfer compartments and is transferred to selected supply compartments of the target surface, and removing the target surface on which the selected supply compartments are filled at least in part with the first transfer fluid.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic top view of a structure and a mode of operation of a target surface according to an embodiment of the invention;

FIG. 2 is a schematic top view of a structure and a mode of operation of a transfer surface according to an embodiment of the invention; and

FIG. 3 is a schematic side view of a sequence of a method according to an embodiment of the invention.

### DETAILED DESCRIPTION

An embodiment of the present invention provides a method for transferring a transfer fluid from a supply surface into a plurality of compartments which are preferably spatially separated from one another (discrete) on a target surface, and also a device (transfer surface) for carrying out the method.

One embodiment provides a method that permits transfer, as quickly as possible and in parallel, of small amounts of the transfer fluid, wherein, on the target surface, the density of discrete compartments into which the transfer fluid is to be introduced is high and in which it nevertheless remains impossible for transfer fluids from discrete compartments which are adjacent to each other to run into each other.

A method according to an embodiment of the invention utilizes a device, referred to as a transfer surface, which is subdivided into individual compartments which are preferably spatially separated from one another (discrete). The surface of the compartments in this case is configured such that the wetting behaviour of the surface of each compartment, independently of a compartment which is adjacent thereto in each case, can be changed by what is called configuring by means of a first high-energy action, preferably by means of light from the ultraviolet spectral range, such that it increases in such a way that the compartment can receive transfer fluid, i.e. is virtually opened. If on the other hand a selected compartment is not subjected to any configuring, it remains virtually closed, i.e. no transfer fluid is received.

The transfer surface which is thus configured is then wetted with a transfer fluid which is received by the virtually opened compartments of the transfer surface. If the transfer surface is then positioned over a target surface, the configuring preferably of all the compartments is cleared over the surface by means of a second high-energy action, preferably by means of light from the visible spectral range, in particular from the green spectral range, or by means of the action of heat. The compartments are thus virtually closed and therefore release the transfer fluid contained in them again, which is thus transferred to a target surface situated beneath the transfer surface.

If the method according to the invention is carried out several times in succession with different transfer fluids in each case which have the same wetting properties as the transfer fluid first used, then in this manner high-density patterns which are formed from various transfer fluids can be produced on the target surface.

A transfer fluid can be any fluid which is provided for location-specific and spatially resolved application in the form of regions on a target surface which are separate from one another. This definition is independent of the use which is to be made of the transfer, in particular whether the fluid remains on the target surface only temporarily, preferably for chemical reactions, or permanently, preferably for printing applications.

Any liquid phase may be suitable as transfer fluid, both a homogeneous fluid, preferably water or another inorganic or organic solvent, a melt of a solid or a liquefied gas, and a physical mixture or a chemical solution of a homogeneous fluid which contains at least one solid and/or at least one further fluid and/or at least one gas. The physical-chemical properties of the liquid phase, in particular its surface tension, polarity and viscosity, in this case depend as a rule on the type and degree of the constituent added. In a method according to an embodiment of the invention, all the transfer fluids used should bring about the same type of wetting. Aqueous solutions may therefore be either hydrophilic or hydrophobic in nature. Transfer fluids which are amphiphilic in nature are unsuitable.

In a method according to an embodiment of the invention, a plurality of transfer fluids are used which differ chemically, in particular with regard to surface tension, polarity, chemical function or reactivity, physically, in particular with regard to viscosity, colour, density or transmission, or biologically, in particular with regard to substances dissolved therein, bacterial cultures, proteins or other biomolecules. Transfer fluids which contain a different dye solution in each case are a simple example of this.

A target surface can be a substrate which has a plurality of regions (compartments) which are provided in each case for filling with a transfer fluid, each compartment being configured such that it is preferably spatially separated from all the other compartments. The target surface itself does not necessarily have to be a flat surface in the geometric sense, but rather may be curved in three-dimensional space, in particular be freestanding, preferably in the form of a thin membrane, or lying against an object.

The material from which a compartment is formed must exhibit a sufficiently good wetting tendency with respect to the transfer fluid used in each case. In this case it is advantageous if the surface of the compartments has a contact angle relative to the transfer fluid used in each case which is less than 90°, preferably below 30°, particularly preferably below 5°. In the case of water as transfer fluid, such a surface is referred to as hydrophilic or as superhydrophilic.

In order to satisfy the abovementioned condition of spatial separation of the individual compartments, it is to be ensured by a suitable configuration of the surface both of the compartments and of the substrate of the target surface that a transfer fluid from a first compartment does not overflow into another compartment, in particular not due to an effect such as capillarity, when a first compartment is filled at least in part with a transfer fluid. In this case, care should be taken that in the case of a relatively high wetting tendency of the compartments higher demands are made in terms of separation of the individual compartments from one another.

In an embodiment, the target surface is selectively modified chemically or physically such that the transfer fluid has a lesser tendency to adhere to the substrate between the compartments. For this, the contact angle against the fluid which is to be poured in is at least greater than 90°, preferably above 150°, particularly preferably above 170°. In the case of water as transfer fluid, such surfaces are referred to as hydrophobic or as superhydrophobic.

Since such a configuration of the target surface is restricted to accessible regions, this does not ensure complete separation of the compartments from one another in every case. In one particularly advantageous embodiment, therefore, the individual compartments are subjected to mechanical-physical separation. In one particular embodiment, the individual compartments are therefore mechanically separated from one another, preferably in the form of a corrugation system, by means of web structures or by the compartments being constructed geometrically as depressions.

If the target surface consists of a porous material, in particular of a membrane, it is advantageous to physically subdivide the membrane. In a preferred embodiment, for this purpose, in a polymeric device which has a honeycomb structure, a separate piece of membrane is provided for each honeycomb structure. One advantageous embodiment consists in introducing into the target surface, by means of a lithographic method, a web structure which closes the porous material locally in each case. For this purpose, first of all the entire membrane is placed in a liquid bath of a liquid photoresist, and in a next step a honeycomb pattern is applied by means of lithography. If the resist is rinsed out in a subsequent step, then, due to the fact that the liquid photoresist can penetrate deep into the porous structure, efficient separation of the individual compartments is achieved.

In an embodiment, empty regions are inserted between the individual compartments. For this purpose, each compartment is configured as an elevated portion which projects by at least 1 μm to 500 μm, preferably 1 μm to 10 μm, relative to the substrate. In this manner, overflowing of the fluids between adjacent compartments is ruled out.

In an embodiment, in the target surface, the transfer fluids poured into the individual compartments do not remain in the respective compartments, but are rinsed out of the compartments, in particular by means of a solvent, by mechanical pressure, preferably by water, gas or air pressure, by means of a microfluidic network or by means of capillarity. In a further embodiment, an effect such as is described below for the transfer surface is used for emptying.

In an embodiment, chemical, physical and/or biological interactions with the transfer fluid take place on the target surface, in particular by repeated application of different transfer fluids, preferably for analysis or for synthesis purposes. Provision is furthermore made for the target surface to be used as the starting substrate for additional applications in which the fluids present in the individual compartments or drying residues or reaction products formed therefrom serve as educts for further reactions.

A transfer surface can transport a plurality of transfer fluids, from a supply surface on which they are made available over the surface, onto the target surface for pouring into particular compartments. Since the transfer surface can serve for structured application and/or structured transferring of the plurality of transfer fluids, it can be configurable. If the transfer surface were not configurable, only patterns over the surface would be transferred, in such a way that all the compartments of the target surface would be filled.

The transfer surface, just like the target surface, can be provided with individual compartments which are located on a substrate. The configuration both of the substrate and of the compartments and also the first step of production of the compartments take place in the same way as for the target surface. In this respect, we refer to the associated explanations.

According to an embodiment of the invention, it is necessary for the transfer surface, during its production, in a further step to be subjected to a modification, which is limited to the compartments. For this purpose, a physical or chemical modification of the surface or of the entire volume of the compartments is carried out by means of a chemical reaction, this modification permanently changing at least the surface of the compartments such that the wetting behaviour of the surface changes and consequently can be configured freely between a first wetting behaviour and a second wetting behaviour which is different therefrom.

In an embodiment, in order to modify the individual compartments, in a second step a chemical reaction by means of a substance dissolved in a fluid (solution) is carried out, which reaction as a result of physical action on the transfer surface, in particular by heating or by high-energy irradiation, binds a molecular structure exclusively within the compartments permanently to the surface of the transfer surface. If in the first step the individual compartments are delimited by means of physical-mechanical barriers, preferably in a honeycomb structure, the solution cannot penetrate into the gaps, as a result of which the chemical reaction in the second step remains restricted to the surface of the compartments. Once the reaction has taken place, the solution is removed and the transfer surface is subjected to a cleaning step.

As a result of the modification of the compartments, a basic state which is stable over time exists, which can be referred to as the first wetting behaviour and is distinguished in that, as long as no configuring of the transfer surface takes place, the first wetting behaviour permanently exists. In a further step, it is possible to convert the wetting tendency of the surface within the compartments temporarily into a second state, which can be referred to as the second wetting behaviour. What is crucial for the mode of operation of the present invention is that transfer fluids which exhibit different behaviours with respect to the first and the second wetting behaviour are used.

According to an embodiment of the invention, when using a selected transfer fluid the second wetting behaviour results in a particular compartment being virtually opened, i.e. the compartment in question being ready to be filled with the transfer fluid used. In this case, the first wetting behaviour which is complementary to the second wetting behaviour must be virtually closed, i.e. the transfer fluid used cannot be poured into another compartment which exhibits the second wetting behaviour. According to an embodiment of the invention, it is however unimportant whether the first wetting behaviour or the second wetting behaviour virtually opens or virtually closes the compartment: it is merely significant that there is the expounded difference between the two wetting behaviours.

According to an embodiment of the invention, for conversion of the first wetting behaviour into the second wetting behaviour and back again remain restricted in each case locally to an individual compartment, i.e. the wetting behaviours of adjacent compartments can be set independently of each other. The conversion takes place by means of a physical and/or chemical effect which can be applied locally to the compartment to be converted, preferably via locally applied heat or radiation, in particular by means of a laser scanner system or a light source from the visible or the ultraviolet spectral range. In this case it is unimportant whether the configuring takes place on the rear side, on the front side or through elements embedded in the transfer surface.

In an embodiment, the physical dimensions of the compartments are in the range from 1 μm to 100 μm, preferably from 1 μm to 10 μm, as a result of which the effects used must be able to be very greatly limited in terms of space. In particular lithographic methods are suitable for this purpose, but mechanical effects, above all due to local application of pressure, or chemical and/or biological effects, preferably due to local application of reagents, can also be used.

The local conversion from the first into the second wetting behaviour can be referred to as configuring. After the configuring, the transfer surface has locally virtually opened compartments for receiving fluids from the supply surface. If the second wetting behaviour, in a preferred embodiment, is not stable over time, after a period of latency it reverts into the stable basic state, which is referred to as first wetting behaviour. In a particularly preferred embodiment of the invention, this operation is accelerated, in particular by a renewed energy input by means of energy radiation or by means of heat. In contrast to the configuring, this step, which is referred to as clearing, in this embodiment takes place on the entire surface of the transfer surface.

In an embodiment, the clearing of a configuration is accelerated. The virtually closed compartments remain closed, whereas the compartments which hitherto have been virtually opened are virtually closed by the solution. In this case, care should be taken that the transfer fluid present in the compartments which have hitherto been opened in each case does not thereby remain in the compartments, which do not form a physically closed-off space. Rather, the fluid present in the respective compartment is expelled due to the change in the wetting behaviour from the second wetting behaviour to the first wetting behaviour. In the event that the contrast between the two wetting behaviours is considerable, the transfer fluid will independently force its way back onto the surface and roll off therefrom. If this effect occurs while the transfer surface is in the immediate vicinity of the target surface, transfer fluid is transferred from the transfer surface to the target surface.

In an embodiment of the invention, the fluid is discharged from the transfer surface onto the target surface such that a particular compartment on the transfer surface for this purpose at this moment is positioned directly above a particular compartment on the target surface. If the distance between the two surfaces is sufficiently small, preferably the surfaces are in direct contact, and if the wetting tendency of the transfer fluid on the target surface at this moment is significantly greater than on the virtually closing compartment on the transfer surface, an almost complete transfer of the transfer fluid from the transfer surface onto the target surface takes place.

In an embodiment of the invention, the configuring of the transfer surface is initiated by a lithographic method. Preferably a maskless lithography system or a scanner system is used for this, with preferably a low wavelength, in particular in the region of the ultraviolet spectrum, serving. The clearing of the configuration takes place in this case by means of exposure to light over the surface at a relatively high wavelength, in particular in the green spectral range, or by heating over the surface of the entire transfer surface. In this case, it is unimportant whether the solution takes place on the rear side, on the front side or from the volume of the transfer surface.

Any physical form of holding a particular transfer fluid available can be referred to as a supply surface. In a method according to an embodiment of the invention only a selected transfer fluid can be present on the supply surface at a particular time. Unlike the transfer surface and the target surface, it is not necessary for the supply surface to be equipped with compartments.

In an embodiment, the supply surface comprises a simple polymeric, ceramic or metallic surface which, like the target surface, does not have to be a geometrically planar surface which is wetted with a thin film of the selected transfer fluid. In this case it is not decisive that a particular supply surface always supplies only a particular transfer fluid: the choice of transfer fluid may according to the invention change over time. In an embodiment, a supply surface first of all supplies a first transfer fluid, and after cleaning at a later time a second transfer fluid.

In an embodiment, the supply surface is also equipped with compartments. Thus a second transfer surface may serve as a supply surface for a first transfer surface. Likewise, a second target surface can be used as the supply surface for a second transfer operation.

According to an embodiment of the invention, it is advantageous if the supply surface has great wettability with respect to the selected transfer fluid, in order to achieve homogeneous wetting of the supply surface with a thin film of transfer fluid. In one particular embodiment, the wetting tendency of the supply surface over time is however not constant, but is changed temporarily, as a result of which the transfer tendency can be improved, similarly to the situation with the transition from the transfer surface to the target surface.

In addition to the supplying of the transfer fluid by means of transferring a thin film from the supply surface to the transfer surface, there are further possible ways of applying the transfer fluids to the transfer surface. In particular, vapour deposition, spotting, centrifuging, spin coating, doctoring, roller transfer and other known methods which are used for transferring fluids and pastes are suitable for this purpose. An embodiment includes a free surface of a reservoir with transfer fluid, the transfer fluid being transferred by bringing the transfer surface into contact with the free surface.

An embodiment of the present invention permits parallel transfer of fluids and is substantially quicker compared in particular with spotting systems, because each point does not have to be set individually. An embodiment of the present invention permits the transfer of substantially smaller amounts of fluids, as a result of which a substantially more beneficial operation becomes possible compared with other systems. Since only small amounts of fluids are transferred, the achievable density of spots of transfer fluid on the target surface is also substantially higher, which is advantageous in particular when the present invention is used in combinatorial chemistry.

Unlike offset printing, An embodiment of the present invention permits the transfer of fluid in discrete compartments, i.e. the possibility of the individual fluid dots running into one another is ruled out. Whereas this effect is undesirable in printing since it produces pixellated images, it represents a significant advantage for applications in the field of an embodiment of the present invention. Finally, clearing of the configuring serves as an initiator for the transfer of the transfer fluid onto the target surface, whereas in offset printing the clearing only takes place when the print roller used has to be reconfigured.

FIG. 1 shows schematically the structure and the mode of operation of a target surface 101 according to an embodiment of the invention in a top view (plan view). The target surface 101 in accordance with FIG. 1a) has a plurality of individual compartments 102, 102′, 102″ which are physically separate from one another. If, as illustrated in FIG. 1b), a transfer fluid is poured into a selected compartment 103, it is impossible for the transfer fluid to overflow into a compartment 104 which is arranged adjacent to the selected compartment 103.

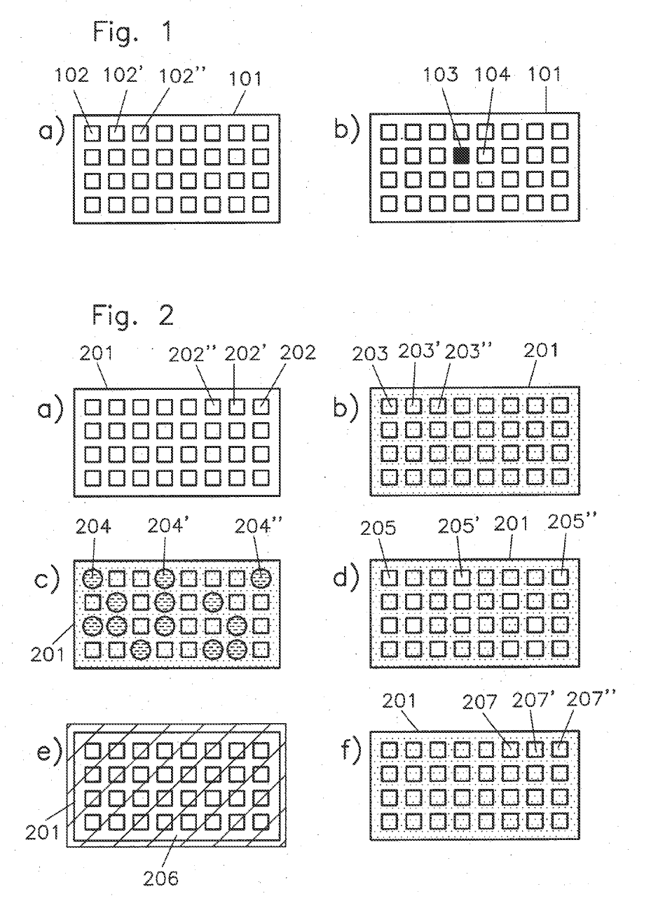

FIG. 2 shows schematically the structure and the mode of operation of a transfer surface 201 according to an embodiment of the invention in a top view. The transfer surface 201 in accordance with FIG. 2a), just like the target surface 101, likewise has a plurality of individual compartments 202, 202′, 202″ . . . which are physically separated from one another. Here too, a physical modification of the substrate ensures that a transfer fluid poured into a selected compartment does not overflow into a second compartment which is adjacent thereto.

Unlike with the target surface 101, in a second step a modification of the compartments 203, 203′, 203″ . . . takes place before the filling of compartments of the transfer surface 201: this makes it possible to convert the individual compartments 203, 203′, 203″ . . . by means of exposure to light and/or thermal treatment from a stable first wetting behaviour into an unstable second wetting behaviour. In FIG. 2b), all the compartments 203, 203′, 203″ . . . have a first wetting behaviour, which is identical to the wetting behaviour of the structures which separate the individual compartments from one another. In this state, all the compartments 203, 203′, 203″ . . . cannot be filled with a transfer fluid; they are referred to as virtually closed.

By exposing selected compartments 204, 204′, 204″. . . in accordance with FIG. 2c) to short-wavelength light, the wetting behaviour of those compartments 204, 204′, 204″ . . . which are exposed to light in each case is changed. In FIG. 2d), the compartments 205, 205′, 205″ . . . which have been exposed to light now exhibit the second wetting behaviour. Thus it is now possible to pour transfer fluid into the compartments 205, 205′, 205″ . . . in each case. The selected compartments 205, 205′, 205″ . . . are now present in a virtually opened state. In this state, the transfer surface 201 can receive transfer fluid 302 from the supply surface 301, which fluid enters exclusively the virtually opened compartments 205, 205′, 205″ . . . .

As illustrated in FIG. 2e), clearing of the transfer surface 201 by action on the entire transfer surface 201 by means of exposure to light at a second wavelength which is longer than the first wavelength, or by means of thermal treatment (heating) takes place. As a consequence of this action, as FIG. 2f) shows, all the compartments 207, 207′, 207″ . . . of the entire transfer surface 201 again have the stable first wetting behaviour. From now on, either selected compartments 207, 207′, 207″ . . . can be virtually re-opened again in a new method in accordance with FIG. 2c) or the entire transfer surface 201 can again be configured completely anew in accordance with FIG. 2a).

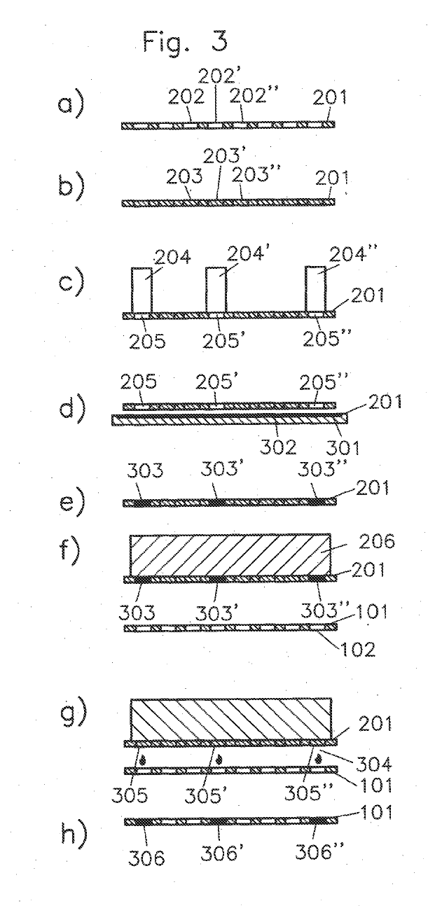

FIG. 3 schematically presents the sequence of a method according to an embodiment of the invention. In accordance with FIG. 3a), a still-unmodified transfer surface 201 is provided which has a plurality of compartments 202, 202′, 203′ which are separated off physically from one another. The compartments 203, 203′, 203″ . . . in the second step in accordance with FIG. 3b) are modified such that they all adopt the first wetting behaviour which is stable over time. The modification has to be carried out only once for the transfer surface 201; it is not necessary to prepare the surface anew after each operation. In this state, all the compartments 203, 203′, 203″ . . . are virtually closed.

In accordance with FIG. 3c), then a configuring of selected compartments by means of lithographic illumination 204, 204′, 204″ takes place, as a result of which individual compartments 205, 205′, 205″ are opened.

In a next step, in accordance with FIG. 3d) the transfer surface 201 is brought into contact with a supply surface 301. The surfaces in FIG. 3d) are drawn separately only for reasons of better presentation, because the transfer of the transfer fluid 302 from the supply surface 301 to the transfer surface 201 advantageously takes place by direct contact of the two surfaces. The virtually opened compartments 303, 303′, 303″, as FIG. 3e) shows, receive transfer fluid, whereas the virtually closed ones, i.e. the compartments which are not switched over during the configuring, cannot receive a transfer fluid and therefore do not receive it during this step either.

Then, as illustrated in FIG. 3f), the transfer surface is positioned above the target surface 101. The target surface 101 in this particularly preferred embodiment has geometrically identically arranged compartments 102, 102′, 102″ . . . , into which the transfer fluid is transferred from the transfer surface 201. For this purpose, the configuring is cleared on the transfer surface 201, in the embodiment of the invention described here by means of exposure to light 206 over the surface or by the application of heat.

As a result of the clearing illustrated in FIG. 3f), as FIG. 3g) shows, the virtually opened compartments 305, 305′, 305″ of the transfer surface 201 close, and expel there the transfer fluid 304 which has been poured into them. The transfer fluid 304 for this purpose either drops off the surface or, in the event that the target surface 101 and the transfer surface 201 are in direct contact with each other, due to the great contrast in wetting behaviour, will be transferred independently into the associated compartment 306, 306′, 306″ of the target surface 101. Finally, the target surface as in FIG. 3h) now has a plurality of selectively filled compartments 306, 306′, 306″.

The method described here can now, preferably once a cleaning step has been carried out on the transfer surface 201 in the meantime, be repeated with preferably a further transfer fluid being transferred from the supply surface 301 via the transfer surface 201 onto the target surface 101.

### EXAMPLE 1

### Production of a Transfer Surface Provided with Compartments with Modification of a Superhydrophilic Surface by Means of an Azo Compound

To carry out the method according to an embodiment of the invention, in a first method step a transfer surface with a plurality of compartments was provided. To produce this transfer surface and its compartments, first of all a glass microscope slide was prepared and cleaned as a substrate. For this, it was rinsed with distilled water, subsequently washed with acetone and dried in a stream of nitrogen. Then it was placed in a solution of methanol and fuming hydrochloric acid (volume ratio 1:1, referred to as “acidic methanol”) for 12 h. After it had been placed therein, the glass microscope slide was cleaned once again with abundant distilled water, subsequently rinsed with acetone and dried in a stream of nitrogen.

Then the glass microscope slide was provided with a web structure. For this, a second microscope slide made of quartz glass (UV-transparent) was placed on the glass microscope slide, separated by a frame made from a thin Teflon film of a thickness of approx. 50 nm. This second microscope slide had been previously placed in a 0.1 M solution of 1H,1H,2H,2H-perfluorooctyldimethylchlorosilane in toluene for 12 h, as a result of which the surface became non-adhesive. The gap produced between the two microscope slides was filled with a prepolymer mixture consisting of a methacrylated perfluorinated polyether diol and 1 mol. % (based on the monomer) 2,2-dimethoxy-2-phenylacetophenone as photoinitiator. The composite was then lithographically structured by means of mask-based lithography using a chromium mask. The exposure to light in this case took place through the quartz glass microscope slide. Using a 300 W Xe arc lamp, after approx. 3 minutes' exposure time a hydrophobic web structure dictated by means of the mask was produced on the surface. After the exposure to light, the quartz glass microscope slide was removed and the glass microscope slide which had been provided with a web structure was rinsed thoroughly with acetone.

In a second method step, the modification of the compartments of the transfer surface was carried out by providing the glass microscope slide [with] a superhydrophilic coating by means of a sol-gel process. For this, first of all the glass microscope slide provided with a web structure was coated with a microscale porous layer. Thereupon, tetraethoxysilane was mixed with methanol and water, the molar ratio in this case being 1:20:5. Then ammonium fluoride (0.02 molar) was admixed to the mixture as a hydrolysis initiator and the solution was stirred for 3 h. Then the freshly cleaned glass microscope slide provided with web structures was placed in this solution and drawn slowly out of the solution; it was then dried in air for 6 hours and finally baked through for 2 h at 220° C. Following this, it was rinsed intensively with distilled water, subsequently rinsed with acetone and dried in a stream of nitrogen. The surface was thereupon slightly opaque and superhydrophilic (contact angle of <5°), which corresponded to the first wetting behaviour.

In a third method step, the surface of the aforementioned glass microscope slide was amino-functionalised. For this, the aforementioned glass microscope slide in the dried state was activated for 12 h in acidic methanol and then was rinsed with distilled water, subsequently rinsed with acetone and dried in a stream of nitrogen. After activation, it was placed in a 1 vol. % solution of aminopropyltriethoxysilane in toluene. Once the glass microscope slide had been removed from the solution, it was rinsed intensively with toluene, and then with acetone, and dried in a stream of nitrogen.

Then the amino-functionalised glass microscope slide was placed in a solution of 10 mmol trifluoromethoxyphenylazophenyl glutarate NHS in DMF and incubated under protective gas for 24 hours. Then the glass microscope slide was washed thoroughly with DMF and acetone. The surface was thereupon superhydrophobic (contact angle of >170°), which corresponded to the second wetting behaviour.

The photoisomerisable azo component trifluoromethoxyphenylazophenyl glutarate NHS was prepared in 3 synthesis steps:

Trifluoromethoxyphenylazophenol was synthesised by taking up 60 mmol trifluoromethoxyaniline in 20 ml concentrated sulphuric acid and 20 ml water with slight heating. Then the solution was cooled to approx. 5° C. in a water bath. Thereupon, a solution of 8 g sodium nitride in 50 ml water was slowly added. This diazotisation solution was then poured slowly at 5° C. into a solution of phenol (70 mml) and NaOH (5 g) in 200 ml water. After the addition, it was checked that the solution remained basic. Once addition had taken place, stirring was continued for 2 hours, the solution was then acidified by means of concentrated HCl and the resulting orange-red solid was extracted by means of filtration. The filter cake was washed with 0.1 M HCl and dried in vacuo.

Trifluoromethoxyphenylazophenyl glutarate was prepared in a second synthesis step. 20 mmol trifluoromethoxyphenylazophenol was taken up in 20 ml dimethylfuran (DMF). Then 22 mmol glutaric anhydride was added and the solution was stirred for 24 h at room temperature.

The photoisomerisable azo component trifluoromethoxyphenylazophenyl glutarate NHS was prepared in a third synthesis step. For this, 22 mmol dicyclohexylcarbodiimide and 30 mmol N-hydroxysuccinimide (NHS) were added to the present solution of trifluoromethoxyphenylazophenyl glutarate in DMF, and the product was stirred at room temperature for 12 h. In this case, dicyclohexylurea was precipitated as a solid. After 12 h, the solution was filtered.

The glass microscope slide thus obtained was exposed to UV light for 30 minutes (˜365 nm, 300 W Xe arc lamp) and in so doing was placed 10 cm away from the light source. In this time, the surface changed from superhydrophobic to superhydrophilic (<10°). The switch over to the superhydrophobic state took place by exposing the microscope slide to light in the visible spectrum (>420 nm) for approx. 3 hours. The wetting angle in so doing increased again to approx. 165°. The surface of the glass microscope slide thus obtained was demonstrably photoswitchable.

In a further method step, the glass microscope slide which had been switched over to superhydrophilic (first wetting behaviour) for fluid transfer was wetted with water as transfer fluid by means of pipetting. The wetted surface was then placed over a filter membrane as target surface and exposed on the rear side to light in the visible spectrum (>420 nm). As a result of switching the transfer surface over from the first to the second wetting behaviour, constriction and ultimately dropping-off of the wetted film of water occurred. Finally, the water-filled target surface was removed.

### EXAMPLE 2

### Use of a Cellulose-Based Substrate

Example 2 differs from Example 1 only in that a cellulose membrane was used as hydrophilic substrate. With this membrane, the cleaning took place by rinsing with bidistilled water and ethanol, followed by drying in a stream of nitrogen. In order to activate the surface, the membrane was treated for approx. 15 minutes [with] a corona plasma, provided by a commercially obtainable portable corona source. Thereafter, the surface became sufficiently hydrophilic to guarantee production of an amino function by means of silanisation. The further processing took place identically to the described procedure in Example 1. In this case, care had to be taken that the membrane was impregnated uniformly with the photopolymerisable prepolymer.

### EXAMPLE 3

### Bringing the Transfer Fluid into Contact

Example 3 differs from Example 1 in that the fluid transfer took place by means of contact with a film of fluid, that is to say the free surface of a vessel filled with the transfer fluid.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for transferring a first transfer fluid from a supply surface into a plurality of discrete supply compartments on a target surface which is configured such that the first transfer fluid has a tendency to adhere more easily to the supply compartments than to the substrate between the supply compartments, the method comprising:
(a) providing a transfer surface which has a plurality of discrete transfer compartments, wherein each transfer compartment can be, independently of all the other transfer compartments, switched between a first wetting behavior with respect to the first transfer fluid and a second wetting behavior having a degree of wetting which is different from that of the first wetting behavior;
(b) setting all of the transfer compartments to the first wetting behavior;
(c) configuring selected transfer compartments to the second wetting behavior using a first high-energy action, so that the selected transfer compartments bear a first configuration;
(d) bringing the transfer surface into contact with the supply surface, as a result of which the selected transfer compartments receive the first transfer fluid applied to the supply surface,
(e) removing the transfer surface from the supply surface, after which second selected transfer compartments contain the first transfer fluid;
(f) positioning the transfer surface above the target surface such that the second selected transfer compartments are disposed above the supply compartments of the target surface;
(g) clearing the configuration of at least a portion of the second selected transfer compartments due to passage of time or by applying a second high-energy action on the transfer surface, as a result of which the first transfer fluid leaves from the second selected transfer compartments and is transferred to selected supply compartments of the target surface; and
removing the target surface on which the selected supply compartments are filled at least in part with the first transfer fluid.

2. The method according to claim 1, wherein steps (b), (c), (d), (e), (f), (g), and (h) or steps (d) (e), (f), (g), and (h) are repeated with second transfer fluid having the same wetting properties as the first transfer fluid.

3. The method according to claim 1, wherein the first transfer fluid comprises a liquid phase which has a homogeneous fluid or a melt of a solid or a liquefied gas or a physical mixture or a chemical solution of a homogeneous fluid, and
wherein the mixture or the solution contains at least one of one solid, at least one further fluid, and at least one gas.

4. The method according to claim, wherein the target surface, includes a substrate on which a contact angle against the transfer fluid has a value which is greater than 90°, and
wherein a contact angle against the transfer fluid on the surface of the supply compartments has a value which is less than 90°.

5. The method according to claim 4, wherein the supply compartments on the target surface are mechanically separated from one another by at least one of a corrugation system including web structures and being constructed geometrically as depressions.

6. The method according to claim 1, wherein configuring the transfer surface involves a lithographic method with a first wavelength, and
wherein clearing at least a portion of the configuration of at least a portion of the second selected transfer compartments involves at least one of exposure over the surface to light at a second wavelength which is longer than the first wavelength, in particular from the green spectral range, and heating over the surface of the transfer surface.

7. A transfer surface having a plurality of discrete transfer compartments arranged on a substrate, wherein each transfer compartment can be, independently of all the other compartments, switched over between a first wetting behavior with respect to a first transfer fluid and a second wetting behavior having a different degree of wetting from that of the first wetting behavior.

8. The transfer surface according to claim 7, wherein the plurality of transfer compartments can be switched over between the first wetting behavior and the second wetting behavior by configuring surfaces of the plurality of transfer compartments by means of a first high-energy action involving radiation from at least one of the visible spectrum and the ultraviolet spectrum.

9. The transfer surface according to claim 7, wherein the substrate of the transfer surface has a contact angle against the first transfer fluid with a value greater than 90, and
wherein the surfaces of the plurality of transfer compartments have a contact angle against the first transfer fluid with a value less than 90°.

10. The transfer surface according to claim 7, wherein the plurality of transfer compartments are mechanically spatially separated from one another by at least one of a corrugation system, including web structures and being constructed geometrically as depressions.
